(19) United States
(12) Patent Application Publication
(10) Pub. No.: US 2006/0248888 A1
(43) Pub. Date: Nov. 9, 2006

(54) System for exhaust gas recirculation in a motor vehicle

(75) Inventor: Peter Geskes, Ostfildern (DE)

Correspondence Address: FOLEY AND LARDNER LLP;SUITE 500, 3000 K STREET NW, WASHINGTON, DC, 20007, US

(73) Assignee: BEHR GmbH & CO. KG

(21) Appl. No.: 11/405,700

(22) Filed: Apr. 18, 2006

(30) Foreign Application Priority Data
Apr. 18, 2005 (DE) 10 2005 017 905.3

(51) Int. Cl. F02B 29/04; F02B 33/44

(52) U.S. Cl. 60/599; 60/605.2

(57) ABSTRACT

A system for recirculation of cooled exhaust gas from a vehicle internal combustion engine includes an internal combustion engine (2) having an intake system (6) and an exhaust gas system (3), an exhaust gas recirculation (EGR) line (10) that contains an exhaust gas cooler (12), an exhaust gas turbine (4) arranged in the exhaust gas system, (3) and a charge air compressor (7) and a charge air cooler (8) arranged in the intake system (6). The exhaust gas stream is extracted at the low pressure side (9) of the exhaust gas turbine (4). An exhaust gas compressor (13) is arranged in the EGR line (10), and the recirculated exhaust gas stream can be fed to the intake system downstream of the charge air cooler (8).

### CROSS-REFERENCE TO RELATED PATENT APPLICATIONS

The right of foreign priority is claimed under 35 U.S.C. § 119(a) based on Federal Republic of Germany Application No. 10 2005 017 905.3, filed Apr. 18, 2005, the entire contents of which, including the specification, drawings, claims and abstract, are incorporated herein by reference.

### BACKGROUND OF THE INVENTION

The invention relates to a heat exchange device and system for cooling recirculated exhaust gas of an internal combustion engine in a motor vehicle.

Exhaust gas recirculation (for short: EGR), especially cooled exhaust gas recirculation, is used in modern vehicles to satisfy mandated reductions in emissions of particulates and pollutants, in particular nitrogen oxides. Since the demands on exhaust gas purification are becoming stricter, greater exhaust gas mass flow rates are required, which are difficult to obtain using known EGR systems.

Known EGR systems are typically arranged on the high pressure side of the internal combustion engine, e.g., as described in U.S. Pat. No. 6,244,256. The known EGR system includes an exhaust gas turbocharger, especially for a diesel engine, and an EGR line having an EGR valve that is arranged between the engine and the exhaust gas turbine. The recirculated exhaust gas is preferably cooled in two stages, that is to say, in two exhaust gas heat exchangers that are each cooled by means of a separate coolant circuit. These are embodied as a high temperature exhaust gas cooler and a low temperature exhaust gas cooler. The cooled, recirculated exhaust gas is then merged with compressed and cooled charge air and fed to the intake system of the engine.

Exhaust gas heat exchangers, in particular exhaust gas coolers, are known in various forms: one comprises a stainless steel welded structure having a bank of exhaust gas pipes, around the outside of which flows a coolant that is taken from the cooling system of the internal combustion engine. See commonly assigned DE 199 07 163 A1.

An EGR system for diesel engines is known from EP 1 203 148 B 1. In this EGR system, the recirculated exhaust gas flow is extracted downstream of an exhaust gas turbine, i.e., at the low pressure side, is cooled and is fed to the fresh air or intake air flow. The mixture of exhaust gas and fresh air passes into a charge air cooler via a compressor and is subsequently fed to the intake region of the diesel engine.

A disadvantage of known EGR systems is that, during cooling of the recirculated exhaust gas, an acidic condensate is produced that can lead to corrosion damage when flowing through an aluminum heat exchanger, in particular a charge air cooler, that is positioned downstream. This problem occurs to a greater extent when the EGR mass flow is extracted at the low pressure side of the exhaust gas turbine.

### SUMMARY OF THE INVENTION

It is one object of the present invention to provide an improved device and system for cooled exhaust gas recirculation, in particular a system that reduces corrosion damage in heat exchangers that are exposed to the exhaust gas.

In accomplishing these objects, there has been provided in accordance with one aspect of the present invention a system for cooled recirculation of the exhaust gas from an internal combustion engine, comprising: an internal combustion engine having an intake system and an exhaust gas system; an exhaust gas recirculation (EGR) line having an exhaust gas cooler; an exhaust gas turbine arranged in the exhaust gas system, wherein the EGR line extracts an EGR stream at a low pressure side of the exhaust gas turbine; a charge air compressor and a charge air cooler arranged in the intake system; an exhaust gas compressor arranged in the EGR line; and a feed junction for feeding the recirculated exhaust gas stream to the intake system downstream of the charge air cooler.

In accordance with another aspect of the invention, there is provided a method for recirculating cooled exhaust gas of an internal combustion engine that includes an intake system and an exhaust gas system, comprising: feeding compressed charge air for the engine through a charge air cooler arranged in the intake system; and feeding a cooled and compressed EGR gas stream to the intake system downstream of the charge air cooler.

In accordance with still another aspect of the invention, there is provided a method for recirculating cooled exhaust gas of an internal combustion engine that includes an intake system and an exhaust gas system, comprising: passing exhaust gas from the engine into an exhaust gas turbine arranged in the exhaust gas system; extracting an exhaust gas recirculation (EGR) stream for an EGR line at a low pressure side of the exhaust gas turbine; feeding charge air for the engine through a charge air compressor and a charge air cooler arranged in the intake system; passing the EGR stream through an exhaust gas compressor and an exhaust gas cooler arranged in the EGR line to produce a cooled EGR stream; and feeding the cooled EGR gas stream to the intake system downstream of the charge air cooler.

Further objects, features and advantages of the present invention will become apparent from the detailed description of preferred embodiments that follows, when considered together with the accompanying figures of drawing.

### BRIEF DESCRIPTION OF THE DRAWINGS

In the drawings:

FIG. 1 is a schematic representation of an EGR system according to one embodiment of the invention having two compressors; and

FIG. 2 is a schematic representation of an EGR system according to another embodiment of the invention having two-stage exhaust gas cooling.

### DETAILED DESCRIPTION OF THE PREFERRED EMBODIMENTS

According to a preferred aspect of the invention, the intake combustion air and the recirculated, cooled exhaust gas are compressed separately. This is preferably achieved by means of two separate compressors, a fresh air or charge air compressor and an exhaust gas compressor, which are preferably arranged on one shaft that is driven by the exhaust gas turbine. This brings about the advantage that the cooled and compressed exhaust gas, which may contain acidic condensate, can be fed directly to the internal combustion engine. The charge air cooler, which is produced from aluminum materials, can therefore be bypassed. The charge air cooler can therefore be exposed only to “clean” fresh air which is compressed by means of the charge air cooler. Corrosion of the aluminum heat exchanger is thus prevented. Another advantage according to the invention is that no separate condensate separator is necessary for the acidic condensate contained in the exhaust gas.

According to one advantageous embodiment of the invention, both compressors are arranged on one shaft, preferably in a common compressor housing, and are sealed off from one another by means of a suitable sealing element, preferably a shaft sealing ring, in such a way that the exhaust gas flow cannot mix with the fresh air flow and such that no condensate can flow into the region of the charge air compressor. As a result, a clean separation of the two gas streams is ensured, and corrosion is prevented, e.g., in the aluminum heat exchanger or charge air cooler or other components of the charge air system.

According to a further advantageous embodiment of the invention, two-stage exhaust gas cooling is provided, e.g., a further exhaust gas cooler is arranged downstream of the exhaust gas compressor. This further exhaust gas cooler cools the exhaust gas to a lower temperature, leading to a further reduction in the emission values of the exhaust gas. The two exhaust gas coolers can be cooled by means of a liquid, preferably the coolant of the engine cooling system, and/or by means of ambient air. For corrosion reasons, at least one and preferably both of the exhaust gas coolers is/are preferably produced from a material that is resistant to corrosion by exhaust gas components, e.g., stainless steel.

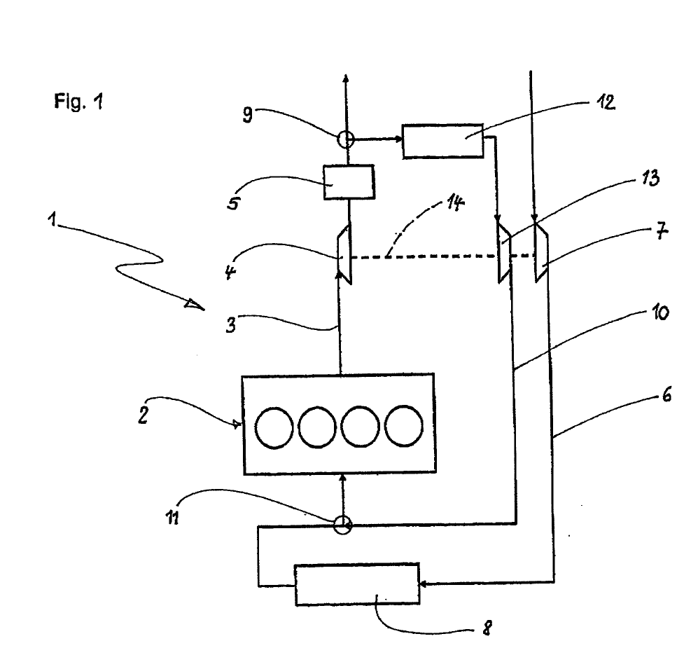

Turning now to the drawings, FIG. 1 shows a schematic illustration of an exhaust gas recirculation (EGR) system 1 having an internal combustion engine 2 that is preferably embodied as a diesel engine. The exhaust gas of the diesel engine 2 passes into an exhaust gas line 3 in which are arranged an exhaust gas turbine 4 and an exhaust gas purification device 5, which preferably includes an oxidizing catalytic converter (not illustrated in detail) and a particulate filter. Compressed and cooled fresh air is fed to the diesel engine 2 via an intake system 6. A charge air compressor 7 and a downstream charge air cooler 8 are preferably arranged in the intake system 6. The charge air cooler 8 is preferably an aluminum heat exchanger, e.g., having aluminum pipes and header tanks made from an aluminum alloy, through which, in particular, the charge air can flow. After passing through the charge air cooler 8, the cooled charge air passes directly into the intake region of the diesel engine 2.

An exhaust gas recirculation stream, which is fed back to the intake region of the diesel engine 2 via an EGR line 10, is extracted from the exhaust gas stream downstream of the exhaust gas turbine 4 at an extraction point 9, at which an EGR valve (not illustrated in detail) can also be arranged. Mixing of the recirculated exhaust gas stream and the cooled charge air stream takes place at the merging point 11. Arranged in the EGR line is an exhaust gas cooler 12 that is preferably cooled by means of the engine coolant of the diesel engine 2. An additional compressor, an exhaust gas compressor 13, is arranged in the EGR line, preferably downstream of the exhaust gas cooler 12. Preferably, the exhaust gas compressor 13 is arranged on the same shaft 14 (illustrated by a dashed line) as the charge air compressor 7 and is driven by the exhaust gas turbine 4. Both compressors, the charge air compressor 7 and the exhaust gas compressor 13, are preferably arranged in a common compressor housing (not illustrated in detail) and are sealed off from one another, preferably by means of a shaft sealing ring (not illustrated in detail) arranged on the common shaft 14. As a result, the exhaust gas stream and the fresh air stream are separated from one another, and acidic condensate in the exhaust gas is prevented from seeping through into the fresh air stream.

As can be seen from the diagram, the cooled and compressed exhaust gas stream bypasses the charge air cooler 8, and the compressed charge air is only admixed downstream of the charge air cooler 8 at the merging point 11. As a result, the charge air cooler 8 is not exposed to recirculated exhaust gas, and thus is also not exposed to any acidic condensate contained in the exhaust gas that would cause corrosion of the aluminum charge air cooler 8. The exhaust gas compressor 13 is adapted to the exhaust gas recirculation rate, that is to say to the desired mass flow, while the charge air compressor 7 is designed for the fresh air flow which is to be fed for the diesel engine 2. The exhaust gas compressor 13 can preferably be designed to be more compact than the charge air compressor 7, since the recirculated exhaust gas mass flow is normally only approximately 20 to 30% of the entire mass flow.

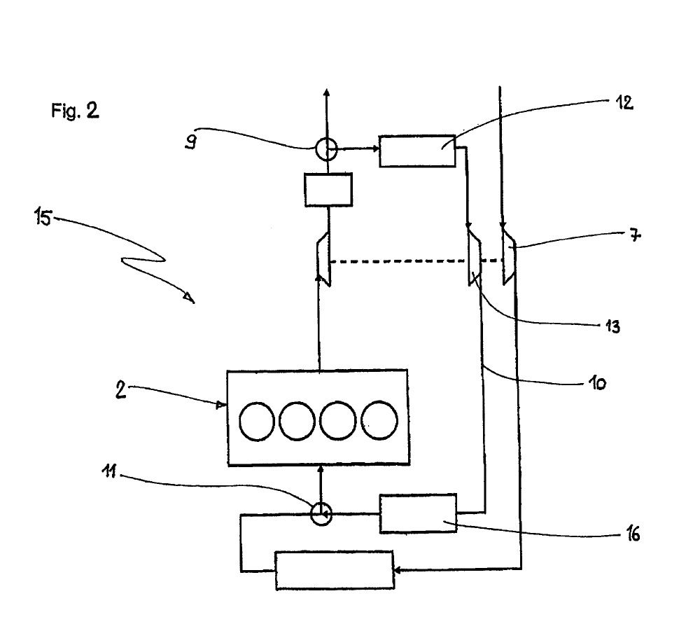

FIG. 2 shows a further exemplary embodiment of the invention, specifically an EGR system 15 having two-stage exhaust gas cooling. The same reference numerals as in FIG. 1 are used for identical components. The exhaust gas is likewise extracted at the low pressure side (downstream of the turbine) at the branching point 9 and is fed back via the EGR line to the merging point 11. In addition to the first exhaust gas cooler 12, a second exhaust gas cooler 16 is arranged downstream of the exhaust gas compressor 13. In the second exhaust gas cooler 16, the exhaust gas can be cooled further, that is to say to a lower temperature level. Preferably, cooling can also be effected here (as in the exhaust gas cooler 12) by means of the coolant from the cooling circuit of the diesel engine 2; however, cooling can also or alternatively be effected by means of ambient air. The emissions in the engine exhaust gas stream can be further reduced by means of the second exhaust gas cooler.

The foregoing description of preferred embodiments of the invention has been presented for purposes of illustration and description only. It is not intended to be exhaustive or to limit the invention to the precise form disclosed, and modifications and variations are possible and/or would be apparent in light of the above teachings or may be acquired from practice of the invention. The embodiments were chosen and described in order to explain the principles of the invention and its practical application to enable one skilled in the art to utilize the invention in various embodiments and with various modifications as are suited to the particular use contemplated. It is intended that the scope of the invention be defined by the claims appended hereto and that the claims encompass all embodiments of the invention, including the disclosed embodiments and their equivalents.

What is claimed is:

1. A system for cooled recirculation of the exhaust gas of an internal combustion engine, comprising:
an internal combustion engine having an intake system and an exhaust gas system;
an exhaust gas recirculation (EGR) line that includes an exhaust gas cooler;
an exhaust gas turbine arranged in the exhaust gas system, wherein the EGR line extracts an EGR stream at a low pressure side of the exhaust gas turbine;
a charge air compressor and a charge air cooler arranged in the intake system;
an exhaust gas compressor arranged in the EGR line; and a feed junction for feeding the recirculated exhaust gas stream to the intake system downstream of the charge air cooler.

2. A system according to claim 1, wherein a drive system for driving the exhaust gas compressor by the exhaust gas turbine.

3. A system according to claim 2, wherein the drive system comprises a common shaft and the charge air compressor and the exhaust gas compressor are arranged on the common shaft.

4. A system according to claim 3, further comprising a separating element between the exhaust gas compressor and the charge air compressor for separating the charge air stream fed by the charge air compressor from the exhaust gas stream fed by the exhaust gas compressor.

5. A system according to claim 1, further comprising a second exhaust gas cooler arranged in the EGR line.

6. A system according to claim 5, wherein the second exhaust gas is positioned downstream of the exhaust gas compressor.

7. A system according to claim 2, further comprising a second exhaust gas cooler arranged in the EGR line.

8. A system according to claim 7, wherein the second exhaust gas is positioned downstream of the exhaust gas compressor.

9. A system according to claim 3, further comprising a second exhaust gas cooler arranged in the EGR line.

10. A system according to claim 9, wherein the second exhaust gas is positioned downstream of the exhaust gas compressor.

11. A system according to claim 4, further comprising a second exhaust gas cooler is arranged in the EGR line.

12. A system according to claim 11, wherein the second exhaust gas is positioned downstream of the exhaust gas compressor.

13. A system according to claim 5, wherein the first and/or the second exhaust gas coolers are cooled by means of a coolant selected from the group consisting of air and a liquid comprising an engine coolant of the internal combustion engine.

14. A system according to claim 7, wherein the first and/or the second exhaust gas coolers are cooled by means of a coolant selected from the group consisting of air and a liquid comprising an engine coolant of the internal combustion engine.

15. A system according to claim 9, wherein the first and/or the second exhaust gas coolers are cooled by means of a coolant selected from the group consisting of air and a liquid comprising an engine coolant of the internal combustion engine.

16. A system according to claim 11, wherein the first and/or the second exhaust gas coolers are cooled by means of a coolant selected from the group consisting of air and a liquid comprising an engine coolant of the internal combustion engine.

17. A system according to claim 5, wherein at least one of the first and second exhaust gas coolers comprises a material that is resistant to corrosion by exhaust gas components.

18. A system according to claim 17, wherein said at least one exhaust gas cooler comprises stainless steel.

19. A system according to claim 1, wherein the charge air compressor and the exhaust gas compressor are of different capacity.

20. A method for recirculating cooled exhaust gas of an internal combustion engine that includes an intake system and an exhaust gas system, comprising:
passing exhaust gas from the engine into an exhaust gas turbine arranged in the exhaust gas system;
extracting an exhaust gas recirculation (EGR) stream for an EGR line at a low pressure side of the exhaust gas turbine;
feeding charge air for the engine through a charge air compressor and a charge air cooler arranged in the intake system;
passing the EGR stream through an exhaust gas compressor and an exhaust gas cooler arranged in the EGR line to produce a cooled EGR stream; and
feeding the cooled EGR gas stream to the intake system downstream of the charge air cooler.

21. A method for recirculating cooled exhaust gas of an internal combustion engine that includes an intake system and an exhaust gas system, comprising:
feeding compressed charge air for the engine through a charge air cooler arranged in the intake system; and
feeding a cooled and compressed EGR gas stream to the intake system downstream of the charge air cooler.
